(19) United States
(12) Patent Application Publication
(10) Pub. No.: US 2009/0223227 A1
(43) Pub. Date: Sep. 10, 2009

(54) Combustion cap with crown mixing holes

(75) Inventors: John Lipinski, Simpsonville, SC (US); Girard Simons, Anderson, SC (US); Jonathan Dwight Berry, Simpsonville, SC (US); Abhijit Som, Greer, SC (US)

Correspondence Address: NIXON & VANDERHYE P.C., 901 NORTH GLEBE ROAD, 11TH FLOOR, ARLINGTON, VA, 22203, US

(73) Assignee: GENERAL ELECTRIC COMPANY, Schenectady, NY (US)

(21) Appl. No.: 12/073,407

(22) Filed: Mar. 5, 2008

(51) Int. Cl. F02C 7/22

(52) U.S. Cl. 60/746; 60/737

(57) ABSTRACT

A combustor liner cap including a cap center body portion and a fuel nozzle portion defined peripherally of the cap center body portion. A plurality of fuel nozzle ports are defined through the fuel nozzle portion and a plurality of air jet holes are defined through the cap center body portion, and each air jet hole is aligned along a radius of the liner cap with a respective fuel nozzle port.

### BACKGROUND OF THE INVENTION

This invention relates to gas and liquid fuel turbines and more specifically to combustors in industrial gas turbines used in power generation plants.

Gas turbines generally include a compressor, one or more combustors, a fuel injection system and a turbine. Typically, the compressor pressurizes inlet air which is then turned in direction or reverse flowed to the combustors where it is used to cool the combustor and also to provide air to the combustion process. In a multi-combustor turbine, the combustors are located about the periphery of the gas turbine, and a transition duct connects the outlet end of each combustor with the inlet end of the turbine to deliver the hot products of the combustion process to the turbine.

In an effort to reduce the amount of NOx in the exhaust gas of a gas turbine, inventors Wilkes and Hilt devised the dual stage, dual mode combustor which is shown in U.S. Pat. No. 4,292,801 issued Oct. 6, 1981 to the assignee of the present invention. In this aforementioned patent, it is disclosed that the amount of exhaust NOx can be greatly reduced, as compared with a conventional single stage, single fuel nozzle combustor, if two combustion chambers are established in the combustor such that under conditions of normal operating load, the upstream or primary combustion chamber serves as a premix chamber, with actual combustion occurring in the downstream or secondary combustion chamber. Under this normal operating condition, there is no flame in the primary chamber (resulting in a decrease in the formation of NOx), and the secondary or center nozzle provides the flame source for combustion in the secondary combustor. The specific configuration of the patented invention includes an annular array of primary nozzles within each combustor, each of which nozzles discharges into the primary combustion chamber, and a central secondary nozzle which discharges into the secondary combustion chamber. These nozzles may all be described as diffusion nozzles in that each nozzle has an axial fuel delivery pipe surrounded at its discharge end by an air swirler which provides air for fuel nozzle discharge orifices.

In U.S. Pat. No. 4,982,570, there is disclosed a dual stage, dual mode combustor which utilizes a combined diffusion/premix nozzle as the centrally located secondary nozzle. In operation, a relatively small amount of fuel is used to sustain a diffusion pilot whereas a premix section of the nozzle provides additional fuel for ignition of the main fuel supply from the upstream primary nozzles directed into the primary combustion chamber.

In a subsequent development, a secondary nozzle air swirler previously located in the secondary combustion chamber downstream of the diffusion and premix nozzle orifices (at the boundary of the secondary flame zone), was relocated to a position upstream of the premix nozzle orifices in order to eliminate any direct contact with the flame in the combustor.

U.S. Pat. No. 5,274,991 discloses a combustor that is a single stage (single combustion or burning zone) dual mode (diffusion and premixed) combustor which operates in a diffusion mode at low turbine loads and in a premixed mode at high turbine loads. Generally, each combustor includes multiple fuel nozzles, each of which is similar to the diffusion/premix secondary nozzle. In other words, each nozzle has a surrounding dedicated premix section or tube so that, in the premixed mode, fuel is premixed with air prior to burning in the single combustion chamber. In this way, the multiple dedicated premixing sections or tubes allow thorough premixing of fuel and air prior to burning, which ultimately results in low NOx levels.

More specifically, in the '991 patent, each combustor includes a generally cylindrical casing having a longitudinal axis, the combustor casing having fore and aft sections secured to each other, and the combustion casing as a whole secured to the turbine casing. Each combustor also includes an internal flow sleeve and a combustion liner substantially concentrically arranged within the flow sleeve. Both the flow sleeve and combustion liner extend between a double walled transition duct at their forward or downstream ends, and a sleeve cap assembly (located within a rearward or upstream portion of the combustor) at their rearward ends. The flow sleeve is attached directly to the combustor casing, while the liner receives the liner cap assembly which, in turn, is fixed to the combustor casing. The outer wall of the transition duct and at least a portion of the flow sleeve are provided with air supply holes over a substantial portion of their respective surfaces, thereby permitting compressor air to enter the radial space between the combustion liner and the flow sleeve, and to be reverse flowed to the rearward or upstream portion of the combustor where the air flow direction is again reversed to flow into the rearward portion of the combustor and towards the combustion zone.

### BRIEF DESCRIPTION OF THE INVENTION

The invention may be embodied in a combustor liner cap comprising a cap center body portion and a fuel nozzle portion defined peripherally of the cap center body portion; wherein a plurality of fuel nozzle ports are defined through the fuel nozzle portion; and wherein a plurality of air jet holes are defined through the cap center body portion, each said air jet hole being aligned along a radius of the liner cap with a respective fuel nozzle port.

The invention may also be embodied in a combustor comprising: a combustor liner; and a combustor liner cap mounted to one axial end of said combustor liner, said combustor liner cap comprising a cap center body portion and a fuel nozzle portion defined peripherally of the cap center body portion; wherein a plurality of spaced fuel nozzle ports are defined through the fuel nozzle portion and wherein a plurality of air jet holes are defined through the cap center body portion, each said air jet hole being aligned along a radius of the liner cap with a respective fuel nozzle port.

### BRIEF DESCRIPTION OF THE DRAWINGS

FIG. 1 illustrates a conventional MNQC (Multi-Nozzle Quiet Combustor) cap and liner assembly;

FIG. 2 is a rear end view of the combustion liner cap assembly taken from the left in FIG. 1;

FIG. 3 is a front end view of the combustor liner cap assembly of FIG. 2;

FIG. 4 is a cross-sectional view taken along lines 4-4 of FIG. 3;

FIG. 5 illustrates an MNQC cap and liner assembly according to an example embodiment of the invention;

FIG. 6 is a rear end view of the combustor liner cap assembly taken from the left in FIG. 5;

FIG. 7 is a front end view of the combustor liner cap assembly of FIG. 6; and

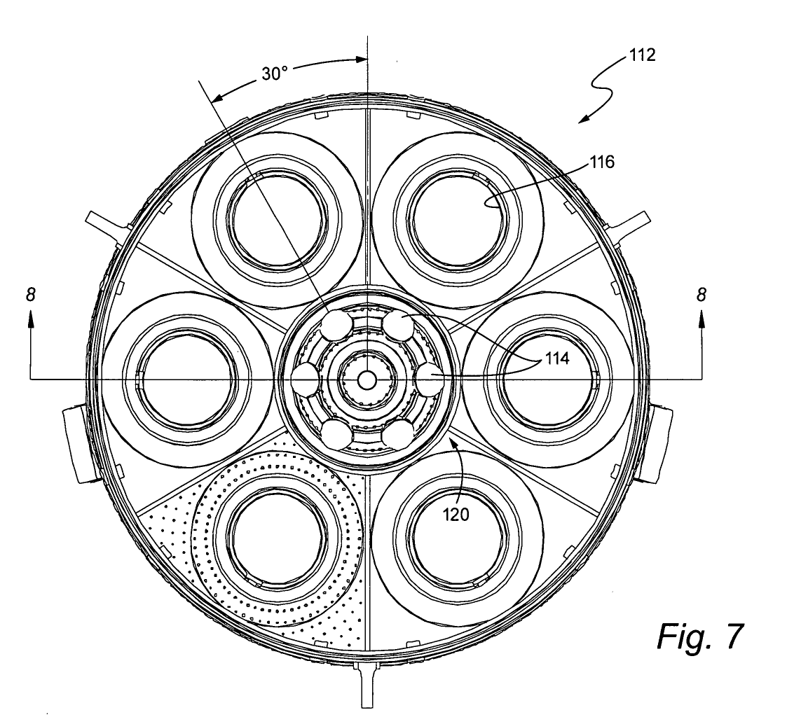

FIG. 8 is view taken along line 8-8 of FIG. 7.

### DETAILED DESCRIPTION OF THE INVENTION

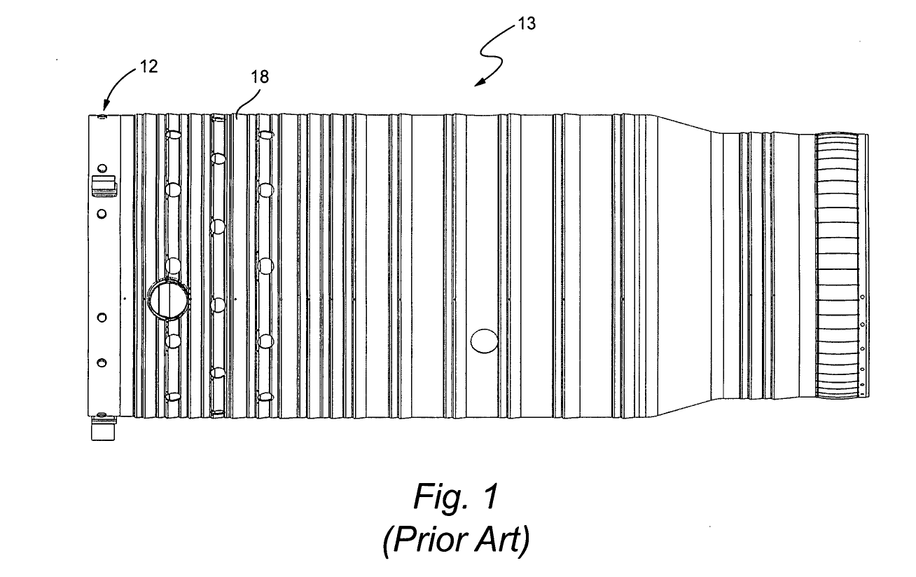

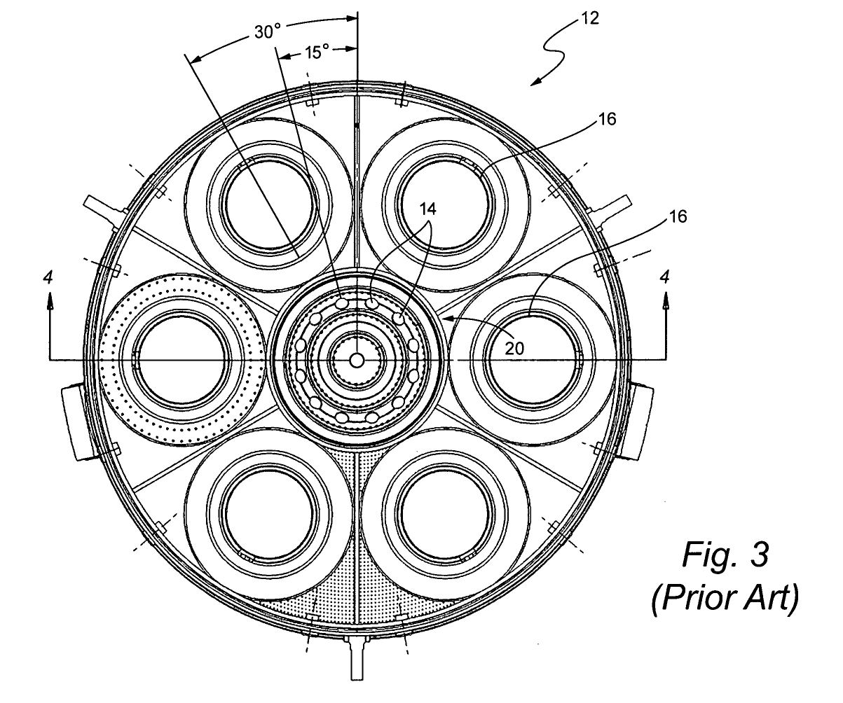

The conventional MNQC cap and liner assembly schematically illustrated in FIGS. 1-3, used for Syngas combustion was found to experience increased CO emissions as the oxygen concentration decreased in the core or center region of the combustor. In an example embodiment of the invention, the oxygen level in the core region is increased. More specifically, the oxygen level is increased in the core region by replacing the conventional small jets that straddled the fuel nozzles with large air mixing jets on the center body that are directed or aimed at each fuel jet. The resulting structure enables improved fuel air mixing in the core, shifted CO emissions turn-up point, increased diluent injection, wider range of operation, and lower NOx emissions.

NOx and CO reduction is limited by insufficient oxygen concentration in the combustor core region. Therefore, conventionally, the combustor was operated near unity in order to achieve stable operations while handling the high diluent flow rates required to meet previous emissions targets. This scenario was a significant obstacle to achieving a more aggressive emissions target. Therefore, in accordance with the invention, air is redistributed in a new center body structure to resolve emissions and operability limitations previously encountered. Thus, invention provides a multi-nozzle diffusion flame combustor that can achieve lower emissions and a larger emissions operating window by stimulating fuel-air mixing in the combustion liner region by adding oriented mixing holes to the cap center-body crown.

The problem addressed by the invention is rather isolated to a multi-nozzle diffusion flame combustion system using diluent for NOx control. Multiple other approaches such as premixed combustion or using a single nozzle burner are known to react the fuel. A premixed approach has the advantage that oxygen is adequately dispersed among the fuel.

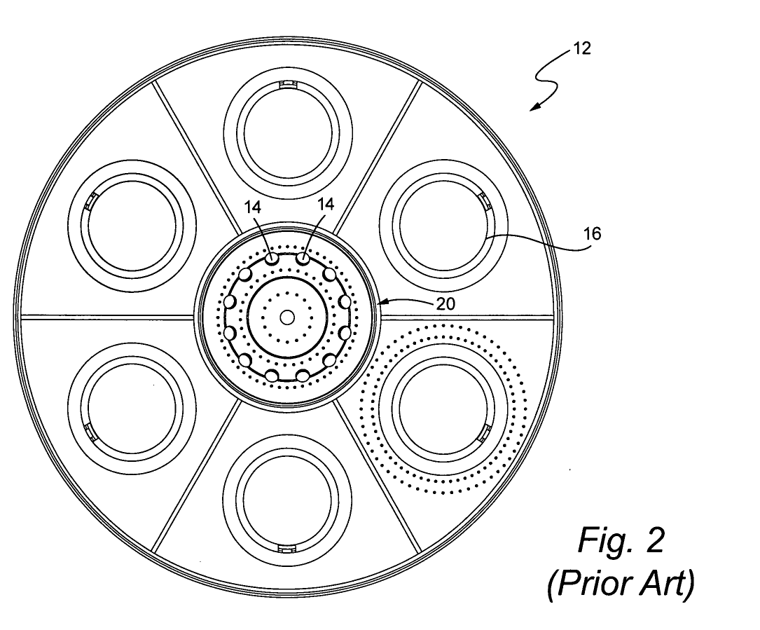

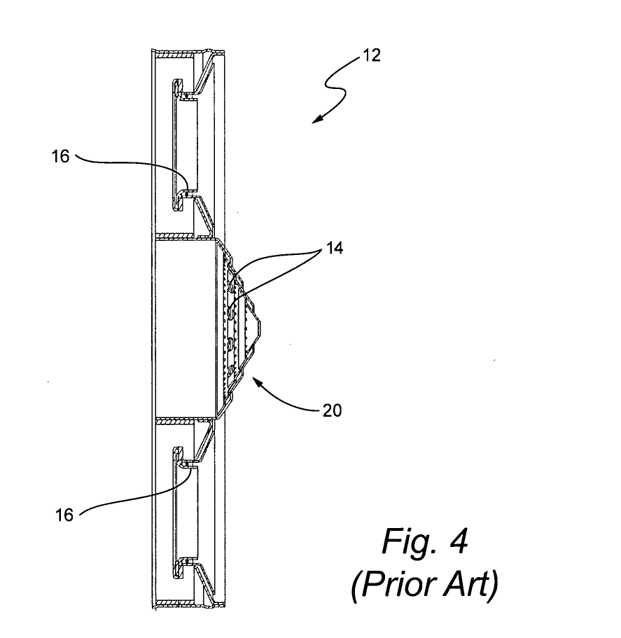

A conventional MNQC (Multi-nozzle Quiet Combustor) cap 12 and liner 14 are illustrated in FIGS. 2 and 1, respectively. The conventional structure illustrated in FIGS. 1-4 employed small air holes or jets 14 and straddled the fuel nozzles 16 and thus injected the majority of air entering the cap center body 20 outward toward the outer wall 18 and the already lean region. Consequently, the conventional mixing hole structure encouraged diluent and combustion products to occupy the liner core region and inhibited CO conversion through a reduced oxygen concentration in the core region.

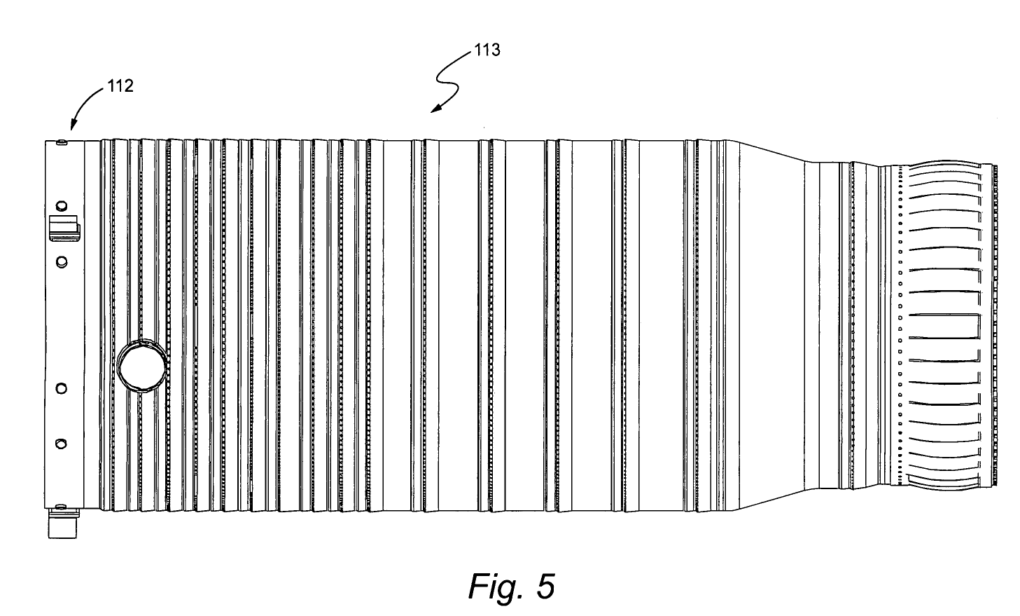

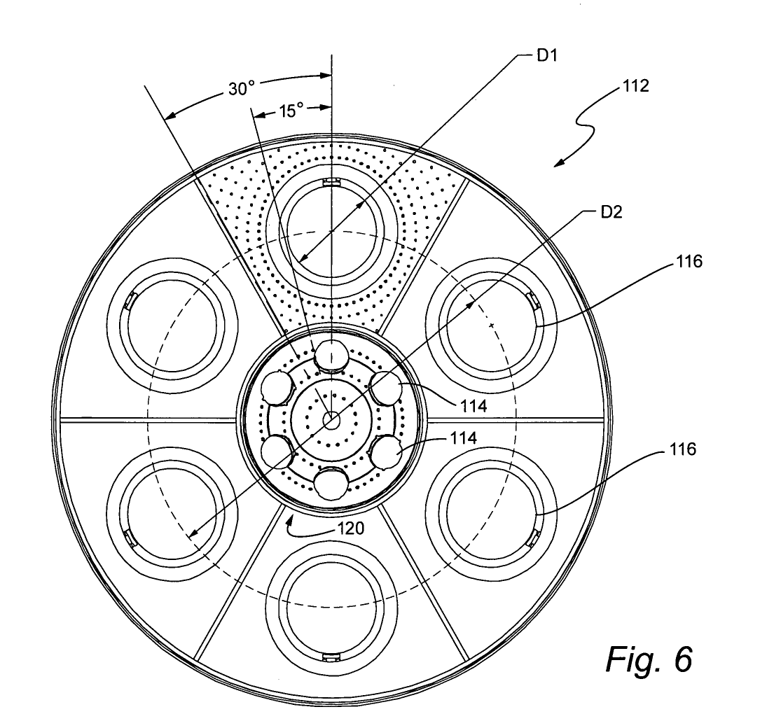

A MNQC cap 112 and liner 114 in accordance with an example embodiment of the invention are illustrated in FIGS. 6 and 5, respectively. In accordance with the invention, rather than twelve small mixing holes or jets 14 of approximately 0.375 inches in diameter, six larger mixing holes or jets 114, each of approximately 0.5 to 1.5 inch, more preferably about 1.0 inch in diameter, are located in the crown of the cap center body 120. Each mixing hole 114 is oriented to be aligned along a radius of the liner cap with a corresponding fuel jet port 116 whereas, as noted above, in the prior art FIG. 2-4 configuration, the mixing holes 14 were oriented to align between adjacent fuel jet ports 16. Thus in this example, where six fuel jet ports 116 are provided, the air jet holes 114 are disposed at 60 degree intervals to align with the fuel jet ports 116. In contrast, the air jets 14 of the FIG. 2-4 cap were disposed at 30 degree intervals so as to be offset by about 15 degrees from the center of the fuel jet ports 16. Fuel nozzle diameters range from 1 to 8 inches. IGCC MNQC nozzles are typically between 2 to 4 inches. In this example embodiment, the fuel jet ports 116 have a diameter D1 of about 2.550 inches and have centers aligned, circumferentially of the liner cap, on a circle of diameter D2 of about 10.500 inches, as in the conventional cap shown in FIGS. 2-4, which is typical for 16 inch liners. For MNQC IGCC units the 14 inch diameter liner has the fuel jet ports aligned on a circle of about 9.5 inches.

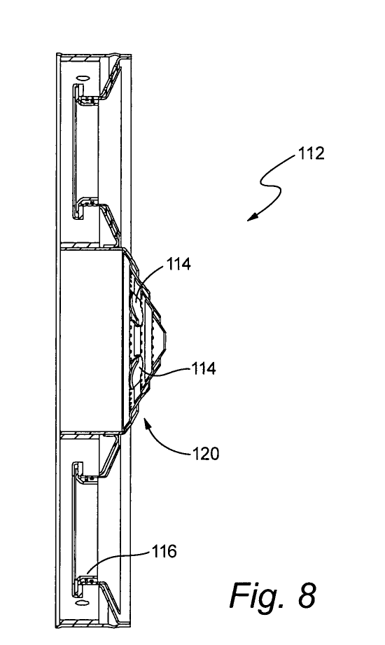

In accordance with the invention, the collision of the fuel and air jets stimulates mixing in the core region of the combustion liner. In the example embodiment illustrated in FIG. 8, air flow through the air jet holes 114 is at an angle to the fuel jets, which in the illustrated embodiment are in an axial direction of the liner, as seen from the orientation of ports 116 in FIG. 8. Specifically, in the example embodiment illustrated in FIG. 8, air flow through the air jet holes 114 is at an angle of about 35 degrees to the axial direction of the fuel jets. As an alternative (not illustrated) the air jet holes can open in a direction perpendicular to the fuel jets.

The increased oxygen provided by the larger openings and improved mixing enable unburned CO to find the O₂ among the combustion bi-products and large diluent flows. The improved CO conversion enables an increased amount of diluent for further NOx reduction.

The novel mixing hole configuration provided in accordance with the invention adds more air to the core region and provides improved mixing. In technical terms, the injection has allowed a dramatic shift in emissions performance to be achieved using a 16″ diameter MNQC liner configuration. The configuration is also shown a significant emissions and operability improvement of previous designs.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims. Thus, as an alternative to an air jet hole aligned along a radius of the liner cap with each of the fuel nozzle ports, there may be fewer air jet holes than fuel nozzle ports. For example there may be three primary air jet holes and six fuel nozzle ports, with each primary air jet hole aligned along a radius of the liner cap with a respective alternate one of the fuel nozzle ports, so that only three of the ports are aligned with an air jet hole, and the ports that are aligned alternate with ports that are not. As another example, there may be four primary air jet holes and six fuel nozzle ports, with each primary air jet hole aligned along a radius of the liner cap with a respective fuel nozzle, so that only four of the ports are aligned with an air jet hole. As yet another alternative to the embodiments described above, if deemed necessary or desirable, one or more secondary air jet holes, e.g., having a diameter less than that of the primary air jet holes, may be interposed between the primary, fuel jet aligned air jet holes. Also, although a liner cap having six fuel nozzle ports has been described and illustrated in detail, it is to be understood that the invention is not limited to a liner cap having six fuel nozzle ports.

What is claimed is:

1. A combustor liner cap comprising a cap center body portion and a fuel nozzle portion defined peripherally of the cap center body portion;
wherein a plurality of fuel nozzle ports are defined through the fuel nozzle portion; and
wherein a plurality of air jet holes are defined through the cap center body portion, each said air jet hole being aligned along a radius of the liner cap with a respective fuel nozzle port.

2. A combustor liner cap as in claim 1, wherein there are six fuel nozzle ports defined peripherally of the cap center body and six air jet holes defined about the cap center body, such that said fuel nozzle ports and said air jet holes have centers on a common radius of the liner cap and respective air jet holes are disposed 60 degrees apart from one another about the cap.

3. A combustor liner cap as in claim 1, wherein each said air jet hole has a diameter of approximately 0.5 to 1.5 inch.

4. A combustor liner cap as in claim 1, wherein each air jet hole is oriented so that air flowing therethrough collides with a fuel from the respective fuel jet whereby a collision of the fuel and air jets stimulates mixing in the core region of a combustor liner to which the cap is mounted.

5. A combustor liner cap as in claim 4, wherein air flow through the air jet holes is at an angle to the respective fuel jets.

6. A combustor liner cap as in claim 5, wherein air flow through the air jet holes is at an angle of about 35 degrees to the respective fuel jets.

7. A combustor liner cap as in claim 1, wherein said air jet holes are uniformly spaced circumferentially of said cap center body.

8. A combustor liner cap as in claim 1, wherein each said fuel nozzle port has a diameter of about 2-4 inches.

9. A combustor liner cap as in claim 1, wherein said fuel nozzle ports are disposed about said fuel nozzle portion so that centers of said fuel nozzle ports are aligned on an imaginary circle having a diameter of about 10.50 inches.

10. A combustor comprising:
a combustor liner; and
a combustor liner cap mounted to one axial end of said combustor liner, said combustor liner cap comprising a cap center body portion and a fuel nozzle portion defined peripherally of the cap center body portion;
wherein a plurality of spaced fuel nozzle ports are defined through the fuel nozzle portion; and
wherein a plurality of air jet holes are defined through the cap center body portion, each said air jet hole being aligned along a radius of the liner cap with a respective fuel nozzle port.

11. A combustor as in claim 10, wherein there are six fuel nozzle ports defined peripherally of the cap center body and six air jet holes defined about the cap center body, such that said fuel nozzle ports and said air jet holes have centers aligned along respective radii of the liner cap and respective air jet holes are disposed 60 degrees apart from one another about the cap.

12. A combustor as in claim 10, wherein each said air jet hole has a diameter of approximately 0.5 to 1.5 inch.

13. A combustor as in claim 10, wherein each air jet hole is oriented so that air flowing therethrough collides with a fuel from the respective fuel jet whereby a collision of the fuel and air jets stimulates mixing in the core region of the combustor liner.

14. A combustor as in claim 13, wherein air flow through the air jet holes is at an angle to the respective fuel jets.

15. A combustor as in claim 14, wherein air flow through the air jet holes is at an angle of about 35 degrees to the respective fuel jets.

16. A combustor as in claim 10, wherein said air jet holes are uniformly spaced circumferentially of said cap center body.

17. A combustor as in claim 10, wherein each said fuel nozzle port has a diameter of about 2.55 inches.

18. A combustor as in claim 10, wherein said fuel nozzle ports are disposed about said fuel nozzle portion so that centers of said fuel nozzle ports are aligned on an imaginary circle having a diameter of about 10.50 inches.
